(19) United States
(12) Patent Application Publication
(10) Pub. No.: US 2007/0103762 A1
(43) Pub. Date: May 10, 2007

(54) Portable communication device with changeable color cueing

(75) Inventor: Ching-Chou Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Chen City (TW)

(21) Appl. No.: 11/453,458

(22) Filed: Jun. 14, 2006

(30) Foreign Application Priority Data
Nov. 9, 2005 (CN) 200510101230.8

(51) Int. Cl. G02F 1/15

(52) U.S. Cl. 359/265

(57) ABSTRACT

An exemplary portable communication device (100) includes a main body (10), an electrically conductive layer (20), and an electrochromic layer (30). The main body has an outer surface. The electrically conductive layer is coated onto the outer surface of the main body. The electrochromic layer contains an electrochromic material. The electrochromic layer is coated onto the electrically conductive layer, and is electrically connected with the main body across the electrically conductive layer.

### TECHNICAL FIELD

The present invention generally relates to portable communication devices, and more particularly to a portable communication device which changes color for the purpose of cueing a user.

### BACKGROUND

With the development of wireless communication and information processing technologies, portable communication devices such as mobile phones are now in widespread use. These portable communication devices enable users to enjoy high technology services anytime and anywhere. In addition, at present many manufacturers make multifunctional portable communication devices such as mobile phones incorporating cameras, thus creating even greater demand for more flexible technologies.

Currently, the portable communication device provides a variety of means for notifying (cueing) the user of a new incoming call or message. For example, the portable communication device may sound a ring tone, play music, or vibrate. However, when the user is in a meeting or on a noisy street, he/she may not hear the ring tone or music. In addition, when the portable communication device is not beside the user's body, he/she may not feel the vibration. Furthermore, sounding the ring tone, playing music and vibrating to cue the user all demand a large amount of power, thus causing greater electricity consumption.

Therefore, it is necessary to provide an improved portable communication device which overcome the above-mentioned problems.

### SUMMARY

A portable communication device according to one embodiment is provided. The portable communication device includes a main body, an electrically conductive layer, and an electrochromic layer. The main body has an outer surface. The electrically conductive layer is coated onto the outer surface of the main body. The electrochromic layer contains an electrochromic material. The electrochromic layer is coated onto the electrically conductive layer, and is electrically connected with the main body across the electrically conductive layer.

Other novel features will become more apparent from the following detailed description, when taken in conjunction with the accompanying drawings.

### BRIEF DESCRIPTION OF THE DRAWINGS

Many aspects of the portable communication device can be better understood with reference to the following drawings. The components in the drawings are not necessarily drawn to scale, the emphasis instead being placed upon clearly illustrating the principles of the present portable communication device. Moreover, in the drawings, like reference numerals designate corresponding parts throughout the several views.

FIG. 1 is an isometric view of a mobile phone in accordance with a first embodiment;

FIG. 2 is an enlarged, schematic, partially cross-sectional view of the mobile phone shown in FIG. 1;

FIG. 3 is a schematic diagram of electrical relationships between certain components of the mobile phone;

FIG. 4 is a flow chart of a preferred operation of the mobile phone shown in FIG. 1; and

FIG. 5 is a schematic, partially cross-sectional view of a mobile phone in accordance with a second embodiment.

### DETAILED DESCRIPTION OF THE EMBODIMENTS

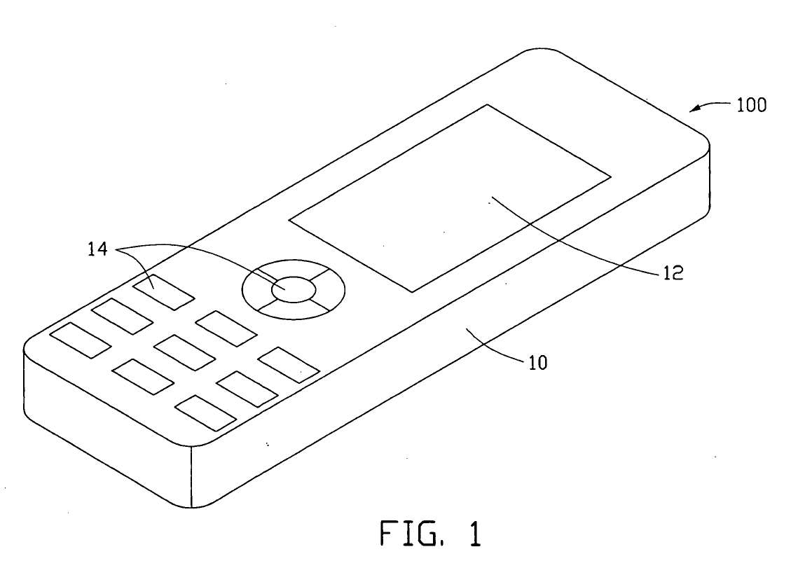

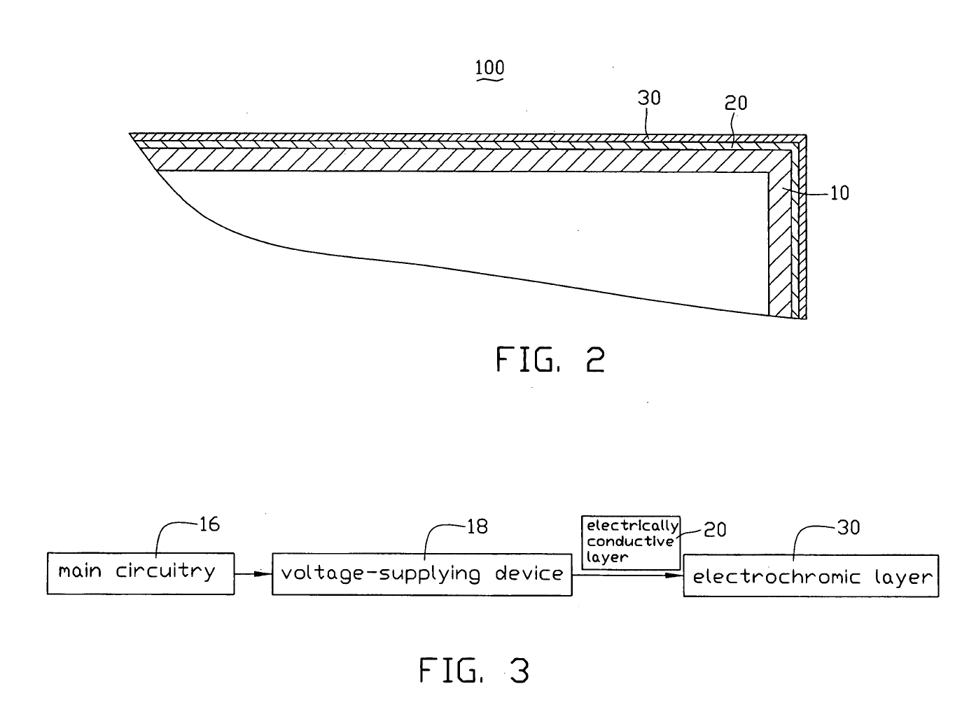

Referring now to the drawings in detail, FIG. 1 shows a mobile phone/portable communication device 100 according to a first embodiment of the present portable communication device with changeable color cueing. The mobile phone 100 is taken here as an exemplary application. Referring also to FIG. 2, the mobile phone 100 includes a main body 10, an electrically conductive layer 20, and an electrochromic layer 30. The electrically conductive layer 20 and the electrochromic layer 30 are coated onto the main body 10 one on top of the other in that order, and the electrochromic layer 30 is electrically connected with the main body 10 across the electrically conductive layer 20, so as to allow color-change of the main body 10.

The main body 10 includes a display portion 12 and a plurality of keys 14. A user controls some functions of the mobile phone 100, for example acknowledging incoming calls or sending messages, by using the keys 14. Referring also to FIG. 3, the main body 10 further includes main circuitry 16 and a voltage-supplying device 18. The main circuitry 16 is configured for providing controlling operations for the mobile phone 100. The voltage-supplying device 18 is configured for supplying different voltages to the electrochromic layer 30. The voltage-supplying device 18 is electronically connected with the main circuitry 16.

The electrically conductive layer 20 contains indium tin oxide to form transparent sheet electrodes. The electrically conductive layer 20 is configured for electrical conduction between the voltage-supplying device 18 and the electrochromic layer 30. The electrically conductive layer 20 may be coated onto a section of an outer surface of the main body 10, for example, between the keys 14, or be coated onto the whole outer surface of the main body 10.

The electrochromic layer 30 contains an electrochromic material, which is transparent and colorless. The electrochromic layer 30 is coated onto the electrically conductive layer 20 by using, for example, spraying, printing or plating. The electrochromic layer 30 is electrically connected with the voltage-supplying device 18 of the main body 10 across the electrically conductive layer 20. The electrochromic layer 30 changes color, for example, from transparent to colored, when a slight voltage is applied. Reversing or neutralizing the voltage causes the electrochromic layer 30 to return to its original color. With different voltages, different colors of the electrochromic layer 30 can be acheived. For example, when supplying a voltage in the range from 1 volt to 2 volts, a navy blue color may be achieved. Thus, the mobile phone 100 can be given a color-change function. The user can open/close the color-change function by using the keys 14 to open/close the voltage-supplying device 18.

The user can program the mobile phone 100 so that pre-identified callers (or senders) can be assigned a particular voltage. The function of cueing the user of the source of incoming calls via the color of the mobile phone 100 is thus enabled.

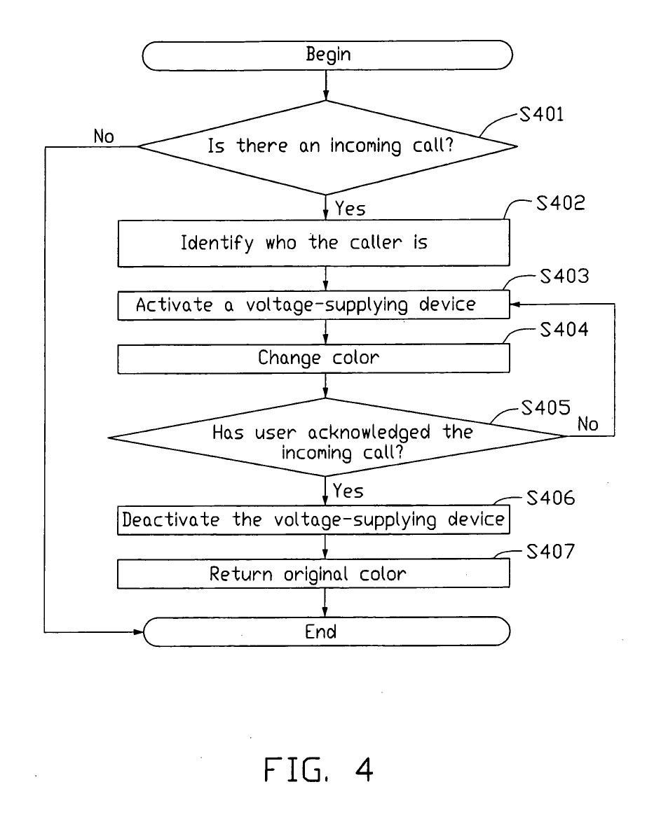

In the following description, it will be assumed that any incoming call (or message) is from a pre-identified caller (or sender), and not from a previously unknown caller (or sender). Referring also to FIG. 4, when an incoming call arrives at the mobile phone 100, the color of the mobile phone 100 is changed as follows. First, in step S401, the main circuitry 16 determines whether there is an incoming call. If there is no incoming call, the procedure is ended. If there is an incoming call, in step S402, the main circuitry 16 identifies who the caller is. Then in step S403, the main circuitry 16 activates the voltage-supplying device 18 to supply a voltage associated with the caller. Next, in step S404, the voltage supplied by the voltage-supplying device 18 is applied across the electrically conductive layer 20, and an electrical current flows to the electrochromic layer 30, thus, the color of the mobile phone 100 is changed. Then, in step S405, the main circuitry 16 determines whether there is a signal or answering message which indicates that the user has acknowledged the incoming call. If the user has not acknowledged the incoming call, the procedure returns to step S403. If the user has acknowledged the incoming call, in step S406, the main circuitry 16 deactivates the voltage-supplying device 18, and there is no electrical current to flow to the electrochromic layer 30. Thus, in step S407, the mobile phone 100 returns to its original color and the procedure is ended. In other words, until the user acknowledges the incoming call, the voltage-supplying device 18 remains activated by the main circuitry 16 of the mobile phone 100, so that the color of the electrochromic layer 30 is changed for the user to be successfully cued to the incoming call.

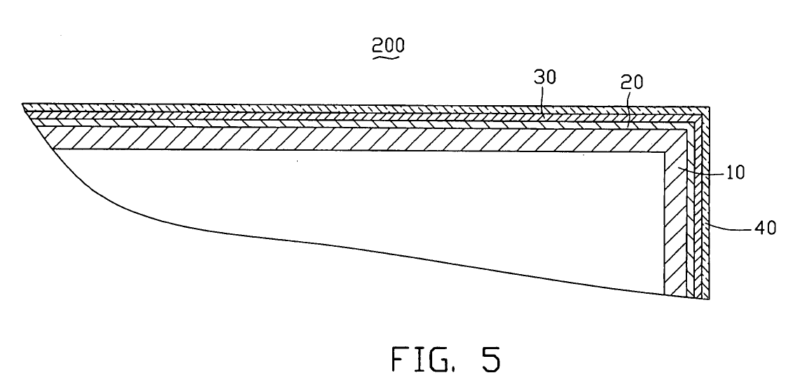

Referring to FIG. 5, a mobile phone 200 according to a second embodiment of the present invention is shown. The mobile phone 200 of the second embodiment is similar to the mobile phone 100 of the first embodiment, except that the mobile phone 200 further includes a surface paint layer 40 coated onto the electrochromic layer 30. The surface paint layer 40 is transparent and colorless, for enhancing luster and brightness of an outer surface of the mobile phone 200.

Compared with a typical mobile phone, the present mobile phone 100 has the following advantages. Firstly, when an incoming call arrives at the mobile phone 100, the electrochromic layer 30 of the mobile phone 100 changes color so as to cue the user. Secondly, when an incoming call arrives at the mobile phone 100, the user can tell who the caller is according to the color of the mobile phone 100. Finally, the electrochromic layer 30 changes color when a slight voltage is applied, thereby saving electricity.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable communication device, comprising:
a main body having an outer surface;
an electrically conductive layer coated onto the outer surface of the main body; and
an electrochromic layer containing an electrochromic material, wherein the electrochromic layer is coated onto the electrically conductive layer, and is electrically connected with the main body across the electrically conductive layer.

2. The portable communication device as claimed in claim 1, wherein the electrically conductive layer contains indium tin oxide to form transparent sheet electrodes.

3. The portable communication device as claimed in claim 2, wherein the main body includes a display portion and a plurality of keys, the electrically conductive layer and the electrochromic layer are coated between the keys of the outer surface of the main body one on top of the other in that order.

4. The portable communication device as claimed in claim 2, wherein the electrically conductive layer and the electrochromic layer are coated onto a section of the outer surface of the main body one on top of the other in that order.

5. The portable communication device as claimed in claim 2, wherein the electrically conductive layer and the electrochromic layer are coated onto the whole outer surface of the main body one on top of the other in that order.

6. The portable communication device as claimed in claim 1, wherein the main body includes a main circuitry and a voltage-supplying device electronically connected with the main circuitry, and the voltage-supplying device is electrically connected with the electrochromic layer for supplying different voltages to the electrochromic layer.

7. The portable communication device as claimed in claim 1, wherein the electrochromic layer is coated onto the electrically conductive layer by using a process chosen from the group consisting of spraying, printing and plating.

8. The portable communication device as claimed in claim 1, wherein the electrochromic layer changes color when a slight voltage is applied.

9. The portable communication device as claimed in claim 1, further comprising a surface paint layer coated onto the electrochromic layer, wherein the surface paint layer is transparent and colorless.

10. A portable communication device, comprising:
a main body with electronic components housed therein;
an electrically conductive layer formed on the main body; and
an electrochromic layer formed on the electrically conductive layer, wherein the electrically conductive layer is configured for electrical conduction between the main body and the electrochromic layer, the electrochromic layer contains an electrochromic material, and the electrochromic material is capable of automatically changing color when a voltage is applied.

11. The portable communication device as claimed in claim 10, wherein the main body includes a main circuitry and a voltage-supplying device electronically connected with the main circuitry, and the voltage-supplying device is electrically connected with the electrochromic layer for supplying different voltages to the electrochromic layer.
